(19) United States
(12) Patent Application Publication
(10) Pub. No.: US 2002/0085257 A1
(43) Pub. Date: Jul. 4, 2002

(54) Optical modulator linearization by direct radio frequency (RF) feedback

(76) Inventor: Fred S. Hirt, Brookfield, IL (US)

Correspondence Address: SCIENTIFIC-ATLANTA, INC., INTELLECTUAL PROPERTY DEPARTMENT, 5030 SUGARLOAF PARKWAY, LAWRENCEVILLE, GA, 30044, US

(21) Appl. No.: 09/754,787

(22) Filed: Jan. 4, 2001

(51) Int. Cl. H04B 10/00; H04B 10/04

(52) U.S. Cl. 359/187; 359/180; 359/161

(57) ABSTRACT

An optical modulator (300) includes a light source (310) for generating an optical beam and an RF input element (305) for injecting an RF signal into the light source (310) for modulating the optical beam with the RF signal to generate an optical signal. The optical modulator (300) also includes a photodiode (315) coupled to the light source (310) for detecting a portion of the optical signal provided by the light source (310), wherein a remaining portion of the optical signal is transmitted to an output port of the modulator (300). A combiner (325) combines the RF signal and the portion of the optical signal, wherein the combiner (325) provides to the light source (310) a corrected RF signal, thereby reducing distortion levels of the remaining portion of the optical signal at the output port of the modulator (300) due to distortions caused internally by the modulator (300).

### FIELD OF THE INVENTION

This invention relates generally to broadband communication systems, such as cable television systems, and optical equipment used in such systems, and more specifically to the transmission of signals in broadband communication systems.

### BACKGROUND OF THE INVENTION

Optical communications systems, such as cable television systems, which include a semiconductor laser, an optical fiber communication link, and an optical receiver, are well known in the art. These communications systems are adapted to carry a wide range of information including voice, video, and data.

The typical optical communications system includes a laser transmitter that modulates an electrical information signal to generate an optical signal. The optical signal is then carried over an optical fiber communications link where it is converted back to an electrical signal by a photodetector of an optical receiver. The transmission scheme may be analog or digital, and the modulation scheme may be amplitude, phase, frequency, or any combination of the above.

One of the most advantageous optical communication systems, from the viewpoint of simplicity and bandwidth efficiency considerations, is an analog scheme where the optical intensity of the semiconductor laser is amplitude modulated. The optical transmission system, including the semiconductor laser, optionally an optical amplifier, and an optical fiber communications link, is required to convert the electrical information signal linearly into an optical signal and to transmit the optical signal linearly over the communications link. In general, distortions caused by the semiconductor laser, the optical amplifier, and the fiber optic communications link may cause the system to operate in less than an optimum manner. Despite these shortcomings, this type of optical communications system plays an important role in the delivery of high quality signals in all types of cable television architectures.

Distortion in optical transmission systems can originate from several different sources. One of the primary sources is the electrical-to-optical transducer, such as a laser diode. Another contributor is the optical communications link and, more recently, any optical amplifier in the optical link. Some of these sources produce similar distortion signals, and some may even cancel others, but usually each distortion has its own unique characteristics and is typically compensated for independently.

In summary, distortions are unintentional, generally unavoidable, byproducts created in the process of modulating an optical field with a time-varying electrical signal. Many techniques exist in prior art to reduce some or most of these distortions. For example, feed-forward methods, in theory, can reduce all orders of distortion; however, these methods have been difficult to apply due to critical phase matching, dispersion, interferometric effects, and other practical limitations. Thus, what is needed is an attainable technique in achieving a reduction in total distortion levels.

### BRIEF DESCRIPTION OF THE DRAWINGS

FIG. 1 is a block diagram of an optical communications system, such as an optical system within a cable television system.

FIG. 2 is a block diagram of a first embodiment of an optical transmitter in accordance with the present invention.

FIG. 3 is a block diagram of a second embodiment of an optical transmitter in accordance with the present invention.

FIG. 4 is a block diagram of a third embodiment of an optical transmitter in accordance with the present invention.

FIG. 5 is a block diagram of a fourth embodiment of an optical transmitter in accordance with the present invention.

### DETAILED DESCRIPTION OF A PREFERRED EMBODIMENT

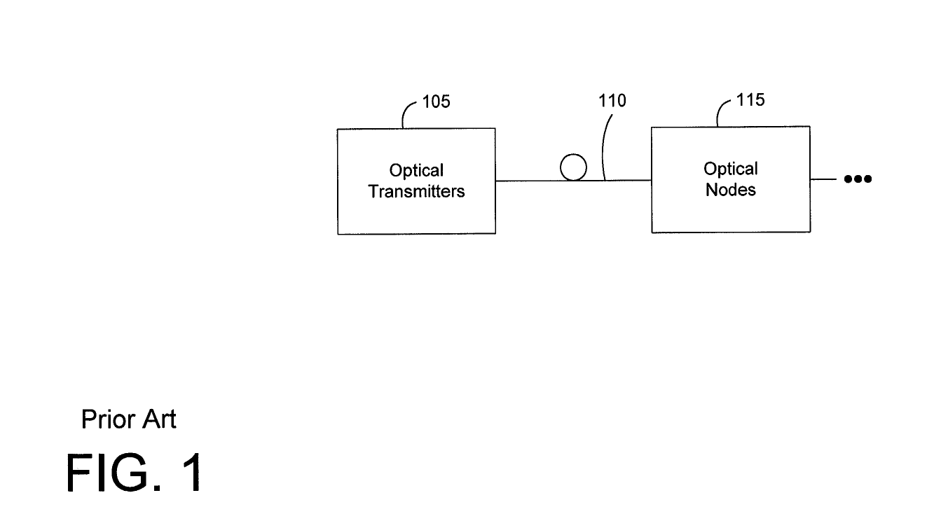

FIG. 1 is a system block diagram of an optical communications system. The system includes an optical transmitter 105, an optical communications link 110, and one or more optical nodes 115. As mentioned briefly in the Background of the Invention, distortions are unintentional, generally unavoidable, byproducts created in the process of modulating an optical field with a time-varying electrical signal. Many techniques exist in prior art to reduce some or most of these distortions, such as the feed-forward technique as described in Pidgeon, et al, U.S. Pat. No. 5,481,389, the teachings of which are incorporated herein by reference.

In accordance with the present invention, direct RF feedback is applied within an optical system. Specifically, the optical linearization is performed within the optical modulator, as opposed to within the chain of RF amplifiers and signal processing components that feed the optical modulator, as is discussed in the above-mentioned patent. Advantageously, the present invention reduces all distortion levels at the output of the modulator. More specifically, in the case of feed-forward techniques, the correction is applied downstream from the point of sampling; therefore, errors in the sampling process, or the correction applied, are not corrected. In contrast, the feedback technique in accordance with the present invention applies its correction upstream from the sampling point, and so compensates for errors, changes, and drifts in both sampling and the correction signal.

Another advantage of the present invention is that, in direct optical feedback error corrections, the correction signal is summed into the RF input, where there is no possibility for coherent optical effects. This differentiates the method and apparatus of the direct optical feedback technique in accordance with the present invention from the feed-forward techniques of prior art. Optical feed-forward techniques require the injection of an optical correction signal into the output optical signal path. This gives rise to a host of problems involving coherent addition of the correction signal with that of the main output signal beam. The result may be uncontrollable amplitude variation, which is more commonly known as breathing, i.e., path dependent phase variations modulating the output amplitude, in addition to polarization-dependent amplitude fluctuations and an increased sensitivity to back reflections at the modulator.

In summary, the present invention achieves direct control of the fidelity of modulation by sampling the composite, modulated optical signal, available at the output of a modulator, and comparing it to the pure, undistorted RF input signal to be modulated in order to generate a correction for a new composite optical signal. The correction is applied to the modulator's input in such a fashion, which is generally, but not limited to 180 degrees out of phase, as to cancel distortion products that arise as generally unavoidable byproducts in the process of modulating an optical field with a time-varying electrical signal.

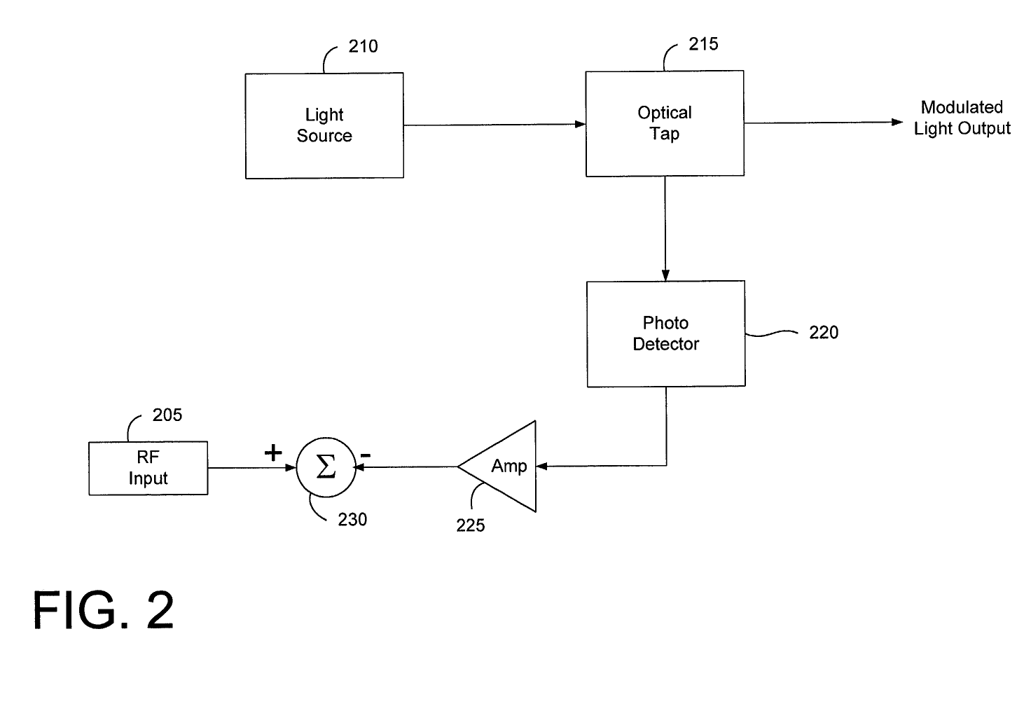

Referring to FIG. 2, a first embodiment of direct modulation of an optical transmitter in accordance with the present invention is shown. An RF input element 205 injects an RF signal to impress, for example, amplitude modulation onto the optical signal provided by the light source 210. In the first embodiment, an optical tap 215 is used to route, for example, ten percent of the composite modulated optical signal to a conventional photodetector 220. Amplification of the sample signal can be provided by the amplifier 225, such as a push/pull linear amplifier, and may provide approximately 15 decibels (dB) of gain across a bandwidth, e.g., 50 MHz to 860 MHz. A summer 230 then adjusts the RF input signal with any required corrections.

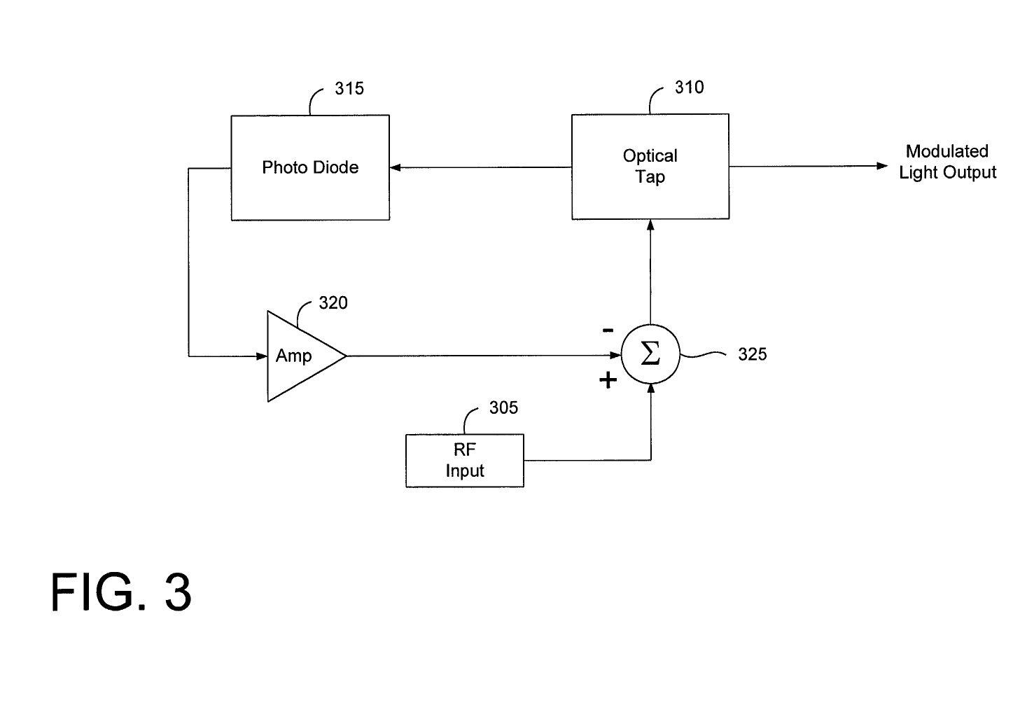

A second embodiment of the present invention is shown in FIG. 3. An RF input element 305 injects an RF signal and modulates an optical signal provided by a distributed feedback (DFB) laser 310. Utilizing a rear facet monitor photodiode 315 as the sampling element, the modulated optical signal is sampled by a P-type intrinsic N-type (PIN) photodiode integrated into the laser die within the DFB laser 310. The photodiode 315 is routinely used for direct current (DC) feedback and control of the laser in order to set the output power of the laser to a constant level. Using the RF signal available at the PIN photodiode reduces time-of-flight, which is typically a critical design parameter, through the optical transmitter 300 to a minimum, thereby improving feedback loop performance. It will be appreciated that the PIN photodiode 315 is shown as a separate item not included within the laser 310 strictly for sake of explanation. The output of the PIN photodiode 315 is coupled to the input of a signal amplifier 320. The amount of gain required by the amplifier 320 may change due to a change in the optical coupling ratio of the rear facet photodiode compared to that of an external optical tap 215 (FIG. 2). As in the embodiment described in reference to FIG. 2, a summer 325 then adjusts the RF input signal with any required corrections.

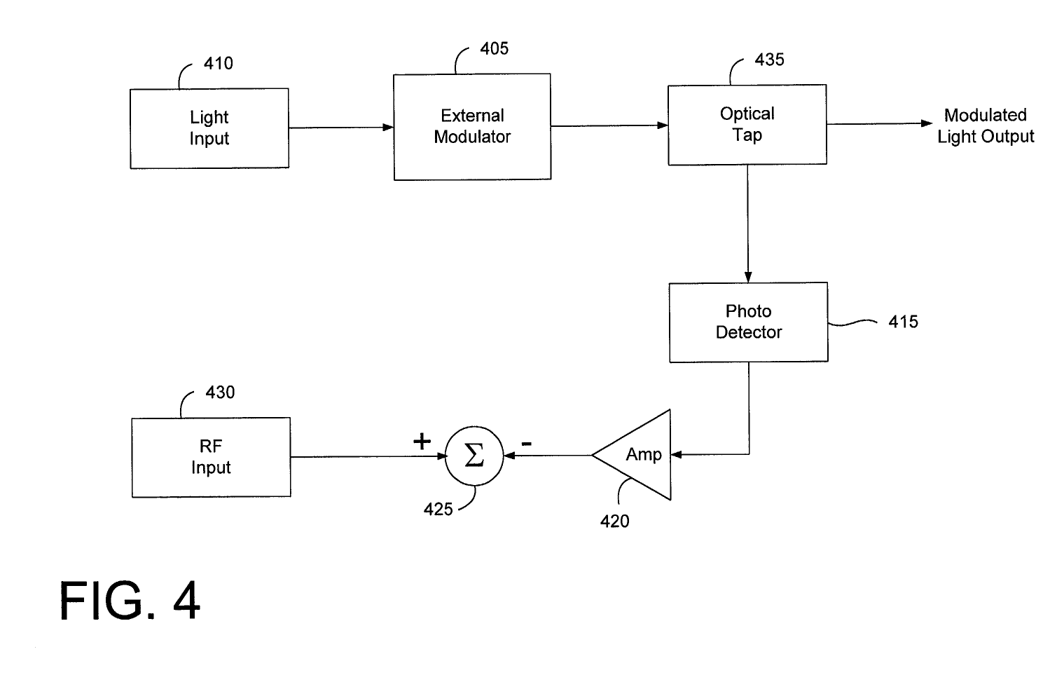

FIG. 4 shows a third embodiment of the present invention. FIG. 4 shows an optical transmitter 400 that uses an external modulator 405 rather than internal modulation. The modulator 405 varies the optical amplitude from a light input 410 with an RF input signal. As in the case of direct modulation, RF feedback control consists of sampling the modulated optical output via a photodetector 415, amplifying the sample with an amplifier 420, and applying the sample signal to a hybrid coupler 425 at the input to the modulator 405. Again, the RF input signal is supplied via an RF input element 430 and an optical tap 435 is coupled to the output of the modulator 405 to sample, for example, ten percent of a composite optical signal, where the composite optical signal includes the modulated optical signal with the summed signal, which is the RF input signal and the RF feedback signal. The amount of gain required in the amplification stage may change due to changes in the modulation transfer function between a directly modulated DFB laser, such as the DFB laser 310 in FIG. 3, and that of the external modulator 405.

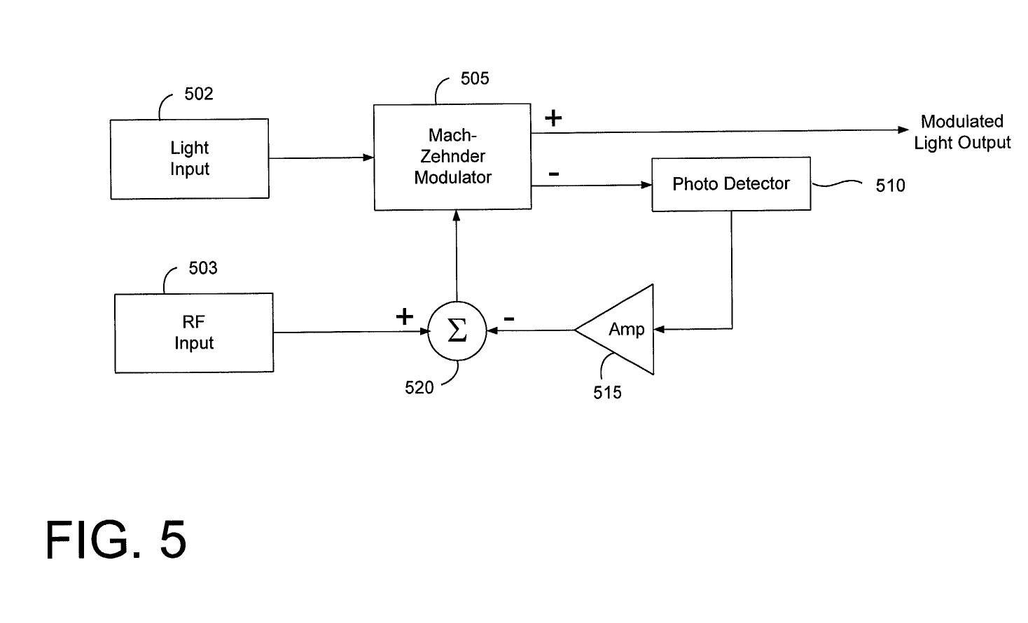

It will be appreciated that an external Mach-Zehnder (M-Z) modulator 505 can also be employed, and the configuration of an optical transmitter 500 including an M-Z modulator 505 is shown in FIG. 5. In this embodiment of the present invention, a light source 502 and an RF input element 503 provide the signals to be modulated and provided to an output of the transmitter 500 for further transmission. The modulated optical signal is sampled by a P-intrinsic-N (PIN) photodiode that is coupled directly to the inverting optical output leg of the M-Z modulator 505. The PIN photodetector 510, such as a fiber-coupled, 50 to 75 micrometer diameter, Indium Gallium Arsenide (InGaAs) photodiode, can be integrated onto the substrate of the M-Z modulator 505, subsequently producing a single integrated optical device capable of RF feedback control to improve linearity. The output of the PIN photodetector 510 of the M-Z modulator 505 is provided to an amplifier 515 and a coupler 520. The coupler 520, or summer, then provides the summed signal that includes the RF input signal and the RF feedback signal.

It will be appreciated that the electrical components used in FIG. 5 do not require an external optical tap or an inverting hybrid coupler in contrast to those of FIGS. 2, 3, and 4. The difference is made possible by the complementary nature of the output legs of the M-Z modulator 505. More specifically, feedback is taken from the M-Z modulator 505 from the out-of-phase, or negative, leg. The negative sign associated with the output of the modulator 505 is determined by the direct current (DC) biasing and control circuitry used to set the M-Z modulator 505 to its operating point. Advantageously, coupling the PIN photodetector 510 directly to the RF amplifier 515, with both the PIN photodetector 510 and the amplifier 515 integrated onto the lithium niobate substrate of the modulator 505, represents a minimum configuration for feedback delay, time-of-flight, and the resulting transient settling time.

In summary, the RF feedback technique achieves direct control of the fidelity of modulation by sampling the composite, modulated optical signal, available at the output of a modulator, and comparing it to the pure, undistorted RF input signal to be modulated in order to generate a correction for a new composite optical signal. In this manner, embodiments of the present invention reduce the total distortion levels at the output of the modulator and are provided further downstream at an optical receiver.

What is claimed is:

1. A modulator, comprising:
a light source for generating an optical beam;
an RF input element for injecting an RF signal into the light source for modulating the optical beam with the RF signal to generate an optical signal;
a photodiode coupled to the light source for detecting a portion of the optical signal provided by the light source, wherein a remaining portion of the optical signal is transmitted to an output port of the modulator; and
a combiner for combining the RF signal and the portion of the optical signal,
wherein the combiner provides to the light source a corrected RF signal, thereby reducing distortion levels of the remaining portion of the optical signal at the output port of the modulator due to distortions caused internally by the modulator.

2. The modulator of claim 1, further comprising:
an amplifier for amplifying the portion of the optical signal for providing an amplified portion of the optical signal to the combiner.

3. The modulator of claim 1, wherein the light source is a distributed feedback laser having an internal splitter for providing the portion of the optical signal to a second output port of the laser.

4. The modulator of claim 1, further comprising:
an optical tap for diverting the portion of the optical signal from the optical signal, and for transmitting the remaining portion of the optical signal.

5. An optical transmitter, comprising:
a light source for generating an optical beam;
an RF input element for injecting an RF signal;
an external modulator for modulating the optical beam with the RF signal to generate an optical signal;
a photodetector coupled to the external modulator for detecting a portion of the optical signal, wherein a remaining portion of the optical signal is provided to an output port of the optical transmitter; and
a combiner for combining the RF signal and the portion of the optical signal,
wherein the combiner provides to the external modulator a corrected RF signal, thereby reducing distortion levels of the remaining portion of the optical signal at the output port of the optical transmitter due to distortions caused internally by the external modulator.

6. The optical transmitter of claim 5, further comprising:
an amplifier for amplifying the portion of the optical signal for providing an amplified portion of the optical signal to the combiner.

7. The optical transmitter of claim 5, wherein the external modulator is a Mach-Zehnder modulator having an internal splitter for providing the portion of the optical signal to a second output port of the external modulator.

8. The optical transmitter of claim 5, further comprising:
an optical tap for diverting the portion of the optical signal from the optical signal, and for providing the remaining portion of the optical signal to the output port of the optical transmitter.

10. A communications system, comprising:
a headend for generating and receiving information signals; and
an optical transmitter for transmitting and receiving optical signals, the optical transmitter, comprising:
a modulator, comprising:
a light source for generating an optical beam;
an RF input element for injecting an RF signal into the light source for modulating the optical beam with the RF signal to generate an optical signal;
a photodiode coupled to the light source for detecting a portion of the optical signal provided by the light source, wherein a remaining portion of the optical signal is transmitted to an output port of the modulator; and
a combiner for combining the RF signal and the portion of the optical signal,
wherein the combiner provides to the light source a corrected RF signal, thereby reducing distortion levels of the remaining portion of the optical signal at the output port of the modulator due to distortions caused internally by the modulator.

11. The modulator of claim 10, further comprising:
an amplifier for amplifying the portion of the optical signal for providing an amplified portion of the optical signal to the combiner.

12. The modulator of claim 10, wherein the light source is a distributed feedback laser having an internal splitter for providing the portion of the optical signal to a second output port of the laser.

13. The modulator of claim 10, further comprising:
an optical tap for diverting the portion of the optical signal from the optical signal, and for transmitting the remaining portion of the optical signal.

14. A communications system, comprising:
a headend for generating and receiving information signals; and
an optical transmitter for transmitting and receiving optical signals, the optical transmitter, comprising:
a light source for generating an optical beam;
an RF input element for injecting an RF signal;
an external modulator for modulating the optical beam with the RF signal to generate an optical signal;
a photodetector coupled to the external modulator for detecting a portion of the optical signal, wherein a remaining portion of the optical signal is provided to an output port of the optical transmitter; and
a combiner for combining the RF signal and the portion of the optical signal,
wherein the combiner provides to the external modulator a corrected RF signal, thereby reducing distortion levels of the remaining portion of the optical signal at the output port of the optical transmitter due to distortions caused internally by the external modulator.

15. The optical transmitter of claim 14, further comprising:
an amplifier for amplifying the portion of the optical signal for providing an amplified portion of the optical signal to the combiner.

16. The optical transmitter of claim 14, wherein the external modulator is a Mach-Zehnder modulator having an internal splitter for providing the portion of the optical signal to a second output port of the external modulator.

17. The optical transmitter of claim 14, further comprising:
an optical tap for diverting the portion of the optical signal from the optical signal, and for providing the remaining portion of the optical signal to the output port of the optical transmitter.
